(19) United States
(12) Patent Application Publication
(10) Pub. No.: US 2017/0108708 A1
(43) Pub. Date: Apr. 20, 2017

(54) NEW TYPE OF RIM AND SPECTACLE FRAME AND SPECTACLES

(71) Applicant: Juei Tse LIN, Taipei (TW)

(72) Inventor: Juei Tse LIN, Taipei (TW)

(21) Appl. No.: 14/883,699

(22) Filed: Oct. 15, 2015

(51) Int. Cl. G02C 1/08; G02C 5/22

(52) U.S. Cl. CPC G02C 1/08; G02C 5/2209; G02C 2200/26; G02C 2200/08

(57) ABSTRACT

A new type of rim and spectacle frame and spectacles. The rim comprises left and right parts, each part has an upper support arm and a lower support arm for gripping the spectacle lens. The inner end of upper support arm is connected to the inner end of lower support arm. Characteristics: the outer end of upper support arm is connected to a turning block rotatably. There is an extension part on the outer end of lower support arm. The turning block rotates to fix one end to the extension part of lower support arm, and it rotates reversely to separate one end from the extension part of lower support arm. There is an elastic piece between the turning block and the outer end of upper support arm, the elastic piece applies elastic pretightening force to limit the contrarotation of turning block.

### BACKGROUND OF INVENTION

1. Field of the Invention

The present invention relates generally to the field of spectacles, and more particularly to a new type of rim and spectacle frame and spectacles.

2. Description of Related Art

The spectacles are closely related to our life. The spectacles on the market can be classified into full-rim spectacles, half-rim spectacles and rimless spectacles. There are upper support arm and lower support arm on the left and right sides of the spectacles frame of full-rim spectacles. The inner and outer ends of upper support arm are fixed to the inner and outer ends of lower support arm, forming a closed structure for assembling spectacle lens. As the upper support arm and lower support arm of full rim are fixed, and the assembly and disassembly are inconvenient, when the user wants to wear different spectacles according to the dress or occasion, it is inconvenient to change the spectacles frame or spectacle lenses.

### SUMMARY OF THE INVENTION

The purpose of the present invention is to overcome the deficiencies in the existing technology to provide a new type of rim and spectacle frame and spectacles.

The technical proposal used in the present invention for solving the technical problems is: a new type of rim, the rim comprises left and right parts, each part has an upper support arm and a lower support arm for gripping the spectacle lens. The inner end of upper support arm is connected to the inner end of lower support arm. The outer end of upper support arm is connected to a turning block rotatably. There is an extension part on the outer end of lower support arm, the turning block rotates to fix one end to the extension part of lower support arm, and it rotates reversely to separate one end from the extension part of lower support arm. There is an elastic piece between the turning block and the outer end of upper support arm. The elastic piece applies elastic pretightening force to limit the contrarotation of the turning block.

Said elastic piece is a spring. The spring is located between the outer end of said upper support arm and the opposite inside of the other end of said turning block.

Said turning block is connected to the outer end of said upper support arm rotatably by a pin. Said elastic piece is a U-shaped elastic buckle clamp. The elastic buckle clamp fits over the pin, and both ends support the outer end of said upper support arm and said turning block respectively.

Said turning block is connected to the outer end of said upper support arm rotatably by a pin. Said elastic piece is a torsion spring. The torsion spring fits over the pin, and both ends support the outer end of said upper support arm and said turning block respectively.

There is a vertically perforated plug hole in the outer end of said upper support arm. There is a locking pin on one end of said turning block. There is a locking hole in the extension part of said lower support arm. When said extension part plugs in the plug hole, the locking hole is exposed outside the top of said plug hole. Said turning block rotates to drive the locking pin to enter or withdraw from the locking hole of said extension part.

Said turning block has a vertically through hole for said pin. There is a gap on the side of said turning block, the gap penetrates through said through hole to divide the through hole into upper and lower parts. The spiral part of said torsion spring is in the gap.

Said turning block has a vertically through hole for said pin. There is a gap on the side of said turning block, the gap penetrates through said through hole to divide the through hole into upper and lower parts. Said elastic buckle clamp matches the gap.

There is a holding groove inside the outer end of said upper support arm. The top of said plug hole is connected to the holding groove. Said turning block is connected to the holding groove rotatably.

A type of spectacle frame comprises two earpieces and a new type of rim stated above. The earpiece is connected to the outer end of said upper support arm.

A type of spectacles comprises two spectacle lenses and said spectacle frame. The two spectacle lenses are assembled in the closed structure formed by said upper support arm and lower support arm.

Beneficial effect of the present invention: the outer end of the upper support arm is connected to a turning block rotatably, there is an extension part on the outer end of lower support arm. The turning block rotates to fix it to the extension part of lower support arm, and it rotates reversely to separate one end from the extension part of lower support arm. There is an elastic piece between the turning block and the outer end of upper support arm. The elastic piece applies elastic pretightening force to limit the contrarotation of turning block, so that the assembly and disassembly of spectacle lenses can be completed quickly only by operating the turning block, convenient hand operation, it is very convenient for the user to change the spectacles frame or spectacle lenses. In addition, the present invention uses an elastic piece for limitation, the turning block grips the extension part of lower support arm more firmly to avoid accidental detachment, and the hand feeling is better.

The present invention is further expounded by the following attached figures and embodiments; but the new type of rim and spectacle frame and spectacles of the present invention is not limited to the embodiments.

### BRIEF DESCRIPTION OF THE DRAWINGS

FIG. 1 is the exploded view of Embodiment 1 of the present invention.

FIG. 2 is the partially enlarged view of exploded Embodiment 1 of the present invention.

FIG. 3 is the structural representation after assembly of Embodiment 1 of the present invention.

FIG. 4 is the structural representation of turning block of Embodiment 2 of the present invention.

FIG. 5 is the exploded view of turning block and torsion spring of Embodiment 3 of the present invention.

FIG. 6 is the exploded view of turning block and elastic buckle clamp of Embodiment 4 of the present invention.

### DETAILED DESCRIPTION OF THE INVENTION

### Embodiment 1

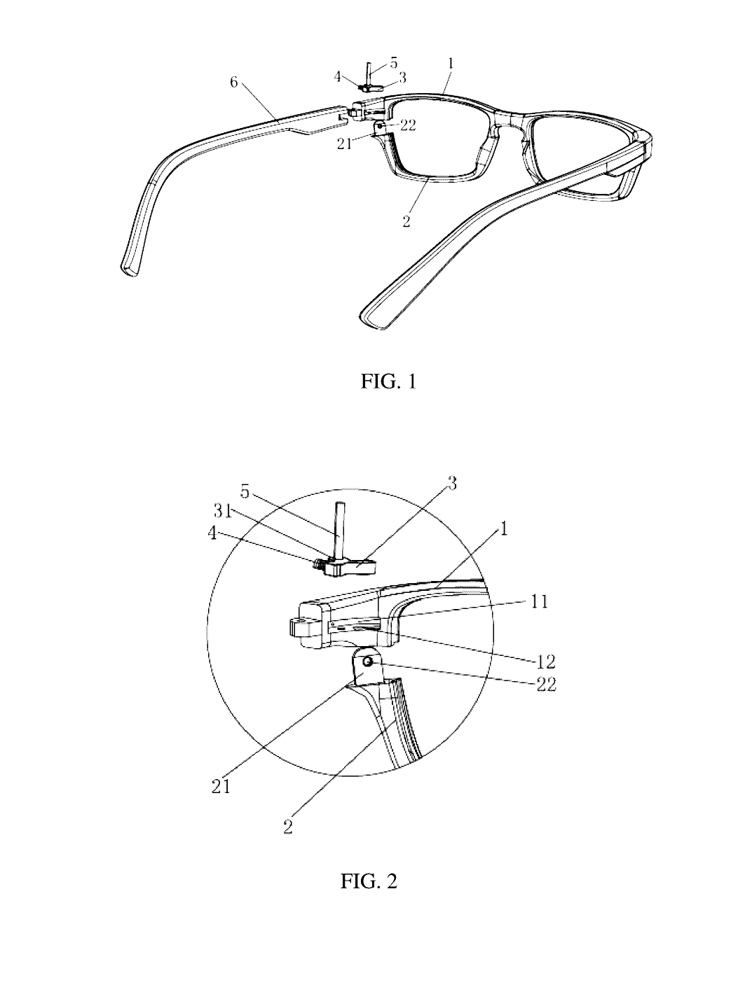

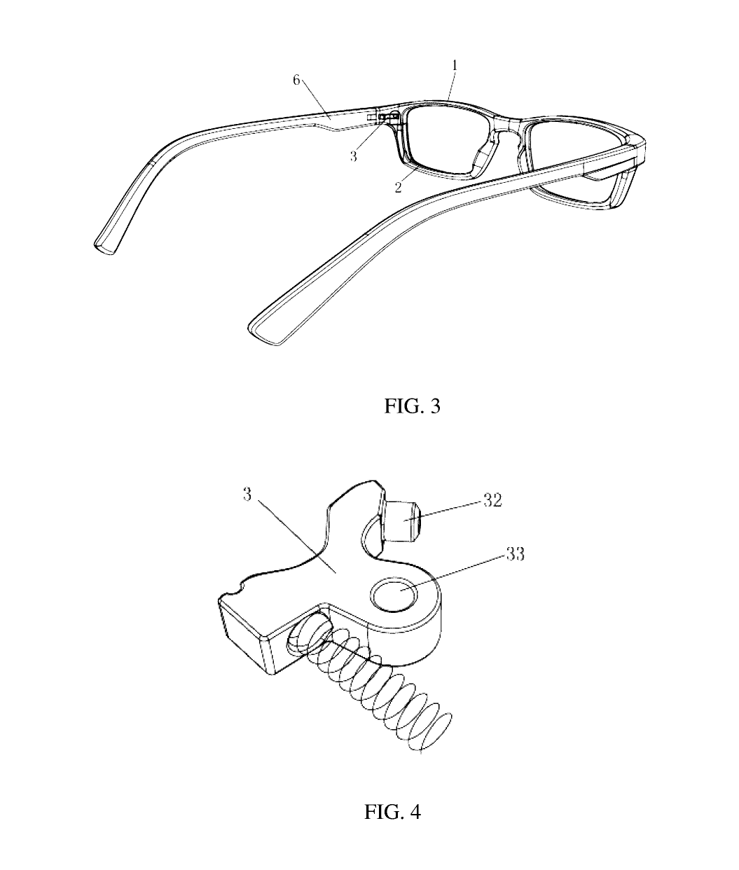

As shown in FIG. 1 to FIG. 3, the present invention provides a new type of rim. The rim comprises left and right parts, each part has upper support arm 1 and lower support arm 2 for gripping spectacle lens, and the opposite inner ends of upper support arm 1 of left and right parts are connected. The inner end of upper support arm 1 is connected to the inner end of lower support arm 2 on the same side. The outer end of upper support arm 1 is connected to a turning block 3 rotatably. There is an extension part 21 on the outer end of lower support arm 2, the turning block 3 rotates to fix one end to the extension part 21 of lower support arm 2, and it rotates reversely to separate one end from the extension part 21 of lower support arm 2. There is an elastic piece between the turning block 3 and the outer end of upper support arm 1. The elastic piece applies elastic pretightening force to limit the contrarotation of turning block 3.

To be specific, there is a vertically perforated plug hole 12 in the outer end of said upper support arm 1. Said extension part 21 penetrates through the plug hole 12, and then it is fixed to or separated from said turning block 3. There is a locking pin 32 on one end of said turning block 3 (as shown in FIG. 4), there is a locking hole 22 in the extension part 21 of said lower support arm 2. When said extension part 21 plugs in the plug hole 12, the locking hole 22 is exposed outside the top of said plug hole 12, said turning block 3 rotates to drive the locking pin 32 to enter or withdraw from the locking hole 22 of said extension part 21.

As an optimization, there is a holding groove 11 inside the outer end of said upper support arm 1. The top of said plug hole 12 is connected to the holding groove 11; said turning block 3 is connected to the holding groove 11 rotatably. To be specific, there is a vertically through hole 31 in the middle of said turning block 3, a pin 5 penetrates through the through hole 31 and connects the holding groove 11, so that said turning block 3 can revolve around the pin 5. The pin 5 can be a threadless pin or a screw.

To be specific, said elastic piece is a spring 4. The spring 4 is located between the outer end of said upper support arm 1 and the opposite inside of the other end of said turning block 3.

As an optimization, said lower support arm 2 is a flexible arm. The inner end of the flexible arm is fixed to the inner end of said upper support arm 1. Added to this, the inner end of said lower support arm 2 can be connected to the inner end of said upper support arm 1 rotatably.

The present invention provides a new type of rim, to assemble the spectacle lens, the other end of turning block 3 is pressed by hand, the locking pin 32 on one end of turning block 3 is rolled out of the holding groove 11 overcoming the force of spring 4. Afterwards, the spectacle lens is placed between the upper support arm 1 and lower support arm 2 of spectacles frame, and the extension part 21 on the outer end of lower support arm 2 penetrates through plug hole 12 from the bottom of outer end of upper support arm 1, till the locking hole 22 in the extension part 21 is exposed outside the top of plug hole 12, i.e. in the holding groove 11. Finally, the turning block 3 is released, it rotates towards the inner end of holding groove 11 under the restoring force of spring 4, till the locking pin 32 is locked in the locking hole 22 of lower support arm 2, so that the extension part 21 of lower support arm 2 is located in the plug hole 12 of upper support arm 1, and the upper support arm 1 and lower support arm 2 form a closed structure, clamping the spectacle lens.

To disassemble spectacle lens, the other end of turning block 3 is pressed by hand, the turning block 3 rotates and drives the locking pin 32 to roll out of holding groove 11 overcoming the force of spring 4. Afterwards, the lower support arm 2 is pulled down to withdraw the extension part 21 from the plug hole 12 of upper support arm 1. Thus, the closed structure formed by upper support arm 1 and lower support arm 2 is opened, the spectacle lens is detached from the spectacles frame.

The present invention provides a new type of rim, under the elastic pretightening force of spring 4, when the lens is assembled, the turning block 3 keeps gripping the lower support arm to avoid accidental separation.

As shown in FIG. 1 to FIG. 3, a type of spectacle frame of the present invention comprises two earpieces 6 and said new type of rim; the earpiece 6 is connected to the outer end of said upper support arm 11.

A type of spectacles of the present invention comprises two spectacle lenses and said spectacle frame. The two spectacle lenses are assembled in the closed structure formed by said upper support arm 1 and lower support arm 2 respectively.

### Embodiment 2

As shown in FIG. 4, the difference between the new type of rim of the present invention and Embodiment 1 is: there is a hemispherical bulge 33 on the upper and lower sides of middle part of said turning block 3 respectively, and the two hemispherical bulges 33 are on the same axis. There is an axle hole in the upper and lower side walls of said holding groove 11 respectively, the two hemispherical bulges 33 of turning block 3 plug in the two axle holes of said holding groove 11 rotatably, so that said turning block 3 can revolve around the axis of the two hemispherical bulges 33.

The present invention provides a new type of rim, in order to implement the turn function of turning block 3, it can be connected to the outer end of upper support arm 1 by using other structures, for example, an axle hole can be made in the turning block 3, the corresponding pin 5 is set on the upper support arm 1.

A type of spectacle frame of the present invention comprises two earpieces and said new type of rim. The earpiece is connected to the outer end of said upper support arm 1.

A type of spectacles of the present invention comprises two spectacle lenses and said spectacle frame. The two spectacle lenses are assembled in the closed structure formed by said upper support arm 1 and lower support arm 2 respectively.

### Embodiment 3

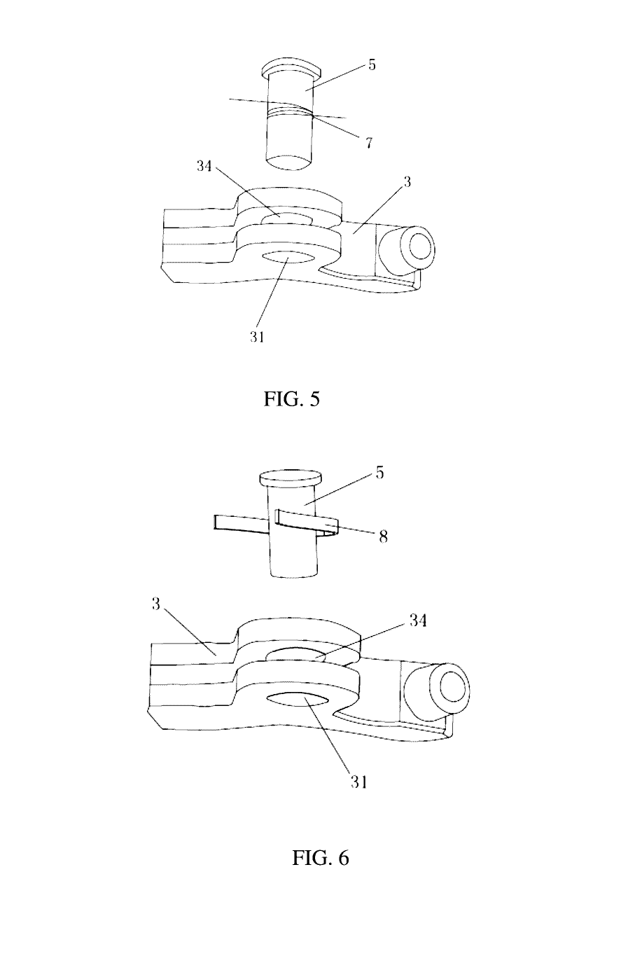

As shown in FIG. 5, the difference between the new type of rim of the present invention and Embodiment 1 is: said elastic piece is torsion spring 7, the torsion spring 7 fits over the pin 5 of turning block 3, and both ends support the outer end of said upper support arm 1 and said turning block 3 respectively. There is a gap on the middle side of said turning block 3, and the gap penetrates through the through hole 31 of said turning block 3, and divides the through hole 31 into upper and lower parts. The spiral part of said torsion spring 7 is in the gap.

The present invention provides a new type of rim, the same as Embodiment 1, to assemble the spectacle lens, the other end of turning block 3 is pressed by hand, the locking pin 32 on one end of turning block 3 is rolled out of the holding groove 11 overcoming the torque of torsion spring 7. Afterwards, the spectacle lens is placed between the upper support arm 1 and lower support arm 2 of spectacles frame, and the extension part 21 on the outer end of lower support arm 2 penetrates through plug hole 12 from the bottom of outer end of upper support arm 1, till the locking hole 22 in the extension part 21 is exposed outside the top of plug hole 12, i.e. in the holding groove 11. Finally, the turning block 3 is released, it rotates towards the holding groove 11 under the restoring force of torsion spring 7, till the locking pin 32 is locked in the locking hole 22 of lower support arm 2, so that the extension part 21 of lower support arm 2 is located in the plug hole 12 of upper support arm 1, and the upper support arm 1 and lower support arm 2 form a closed structure, clamping the spectacle lens.

To disassemble spectacle lens, the other end of turning block 3 is pressed by hand, the turning block 3 rotates and drives the locking pin 32 to roll out of holding groove 11 overcoming the torque of torsion spring 7. Afterwards, the lower support arm 2 is pulled down to withdraw the extension part 21 from the plug hole 12 of upper support arm 1. Thus, the closed structure formed by upper support arm 1 and lower support arm 2 is opened, the spectacle lens is detached from the spectacles frame.

A type of spectacle frame of the present invention comprises two earpieces and said new type of rim. The earpiece is connected to the outer end of said upper support arm.

A type of spectacles of the present invention comprises two spectacle lenses and said spectacle frame. The two spectacle lenses are assembled in the closed structure formed by said upper support arm and lower support arm respectively.

### Embodiment 4

As shown in FIG. 6, the difference between the new type of rim of the present invention and Embodiment 1 is: said elastic piece is a U-shaped elastic buckle clamp 8, the elastic buckle clamp 8 fits over the pin 5 of said turning block 3, and both ends support the outer end of said upper support arm 1 and said turning block 3 respectively. The same as Embodiment 3, there is a gap on the middle side of said turning block 3, and the gap penetrates through the through hole 31 of said turning block 3, and divides the through hole 31 into upper and lower parts. The spiral part of said elastic buckle clamp 8 is in the gap.

The present invention provides a new type of rim, the same as Embodiment 1, to assemble the spectacle lens, the other end of turning block 3 is pressed by hand, the locking pin 32 on one end of turning block 3 is rolled out of the holding groove 11 overcoming the elastic force of elastic buckle clamp 8. Afterwards, the spectacle lens is placed between the upper support arm 1 and lower support arm 2 of spectacles frame, and the extension part 21 on the outer end of lower support arm 2 penetrates through plug hole 12 from the bottom of outer end of upper support arm 1, till the locking hole 22 in the extension part 21 is exposed outside the top of plug hole 12, i.e. in the holding groove 11. Finally, the turning block 3 is released, it rotates towards the holding groove 11 under the restoring force of elastic buckle clamp 8, till the locking pin 32 is locked in the locking hole 22 of lower support arm 2, so that the extension part 21 of lower support arm 2 is located in the plug hole 12 of upper support arm 1, and the upper support arm 1 and lower support arm 2 form a closed structure, clamping the spectacle lens.

To disassemble spectacle lens, the other end of turning block 3 is pressed by hand, the turning block 3 rotates and drives the locking pin 32 to roll out of holding groove 11 overcoming the elastic force of elastic buckle clamp 8. Afterwards, the lower support arm 2 is pulled down to withdraw the extension part 21 from the plug hole 12 of upper support arm 1. Thus, the closed structure formed by upper support arm 1 and lower support arm 2 is opened, the spectacle lens is detached from the spectacles frame.

A type of spectacle frame of the present invention comprises two earpieces and said new type of rim. The earpiece is connected to the outer end of said upper support arm 1.

A type of spectacles of the present invention comprises two spectacle lenses and said spectacle frame. The two spectacle lenses are assembled in the closed structure formed by said upper support arm and lower support arm respectively.

Although the invention has been explained in relation to its preferred embodiment, it is to be understood that many other possible modifications and variations can be made without departing from the spirit and scope of the invention as hereinafter claimed.

1-10. (canceled)

11. A rim for eyeglasses comprising:
an upper support arm;
a lower support arm;
rotatable turning blocks each comprising a locking pin that releasably connects each opposed end of the upper support arm to a respective opposed end of the lower support arm; and
an elastic piece engaged with each turning block so as to bias the respective turning block toward a connected position.

12. The rim for eyeglasses of claim 11, wherein said elastic piece is a spring arranged between the end of the respective upper support arm and the turning block.

13. The rim for eyeglasses of claim 11, wherein each turning block is connected to the end of the respective upper support arm by a pin and wherein each elastic piece is a u-shaped elastic buckle clamp fitting over the pin.

14. The rim for eyeglasses of claim 11, wherein each turning block is connected to the end of the respective upper support arm by a pin and wherein each elastic piece is a torsion spring fitting over the pin.

15. The rim for eyeglasses of claim 11, further comprising a vertically extending plug hole in the end of each upper support arm and a locking hole in an extension part of each lower support arm wherein the extension part engages in the plug hole such that the locking hole is exposed and such that the locking pin is free to enter or withdraw from the locking hole of the extension part to connect or release the upper and lower support arms respectively.

16. The rim for eyeglasses of claim 13, wherein each turning block has a vertically extending hole for the pin and a gap at a side of the turning block penetrating through the hole so as to divide the hole into upper and lower parts and wherein a spiral part of the u-shaped elastic buckle clamp is arranged in the gap.

17. The rim for eyeglasses of claim 14, wherein each turning block has a vertically extending hole for the pin and a gap at a side of the turning block penetrating through the hole so as to divide the hole into upper and lower parts and wherein a spiral part of the torsion spring is arranged in the gap.

18. The rim for eyeglasses of claim 15, further comprising a holding groove formed inside the end of each upper support arm where a top of the plug hole is connected to the holding groove.

19. A spectacle frame comprising two earpieces and the rim for eyeglasses of claim 11, wherein each earpiece is connected to a respective end of the upper support arm.

20. Spectacles comprising two spectacle lenses and the rim for eyeglasses of claim 11, wherein the two spectacle lenses are assembled in a closed structure formed by the connected upper support arm and lower support arm.
